(19) United States
(12) Patent Application Publication
(10) Pub. No.: US 2025/0156919 A1
(43) Pub. Date: May 15, 2025

(54) TECHNIQUES FOR CONTENT RECOMMENDATION IN MULTIMEDIA ENVIRONMENTS

(71) Applicant: Roku, Inc., San Jose, CA (US)

(72) Inventors: Andrew Peter Fogg, Los Gatos, CA (US); Charles Brian Pinkerton, Boulder, CO (US); Sunil Ramesh, Saratoga, CA (US); Michael Patrick Cutter, Golden, CO (US); David Lee Stern, Los Gatos, CA (US); Ronica Jethwa, Mountain View, CA (US)

(73) Assignee: Roku, Inc., San Jose, CA (US)

(21) Appl. No.: 18/505,398

(22) Filed: Nov. 9, 2023

(51) Int. Cl. H04N 21/25; G06T 19/00; H04N 21/442

(52) U.S. Cl. CPC G06Q 30/0625

(57) ABSTRACT

A method is described and includes presenting a stimulus to a user, wherein the stimulus comprises at least a portion of a first item of content and includes audio, video, or both; detecting at least one non-verbal reaction of the user to the stimulus; processing the detected at least one non-verbal reaction to determine a response of the user to the stimulus; providing to the user a list of recommendations based on the determined response of the user to the stimulus, wherein the list of recommendations comprises at least one second item of content selected from a content database; and prompting the user to select an item of content from the list of recommendations.

### TECHNICAL FIELD

This disclosure relates generally to multimedia systems, and more specifically, to techniques for content recommendation for individuals and groups in connection with such multimedia environments.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a block diagram of an example multimedia environment according to some embodiments of the disclosure.

FIG. 2 illustrates a block diagram of an example media device according to some embodiments of the disclosure.

FIG. 3 illustrates a flow diagram of example operations performed according to some embodiments of the disclosure.

FIG. 4 illustrates a flow diagram of example operations performed according to other embodiments of the disclosure.

FIG. 5 illustrates a flow diagram of example operations performed according to other embodiments of the disclosure.

FIG. 6 illustrates a flow diagram of example operations performed according to other embodiments of the disclosure.

FIG. 7 illustrates a block diagram of an exemplary computing device, according to some embodiments of the disclosure.

### DETAILED DESCRIPTION

### Overview

Content providers may manage and allow users to access and view thousands to millions or more content items. Content items may include media content, such as audio content, video content, image content, extended reality (XR) content (which may include one or more of augmented reality (AR) content, virtual reality (VR) content, and/or mixed reality (MR) content), gaming content, etc. Finding exactly what a user is looking for and/or recommending content that the user may find interesting or relevant can greatly enhance the user experience. In some cases, a user may provide verbal or text-based queries to find content items and/or to prompt content recommendations. Examples of queries may include:
“Show me funny office comedies with romance”
“TV series with strong female characters”
“I want to watch 1980s romantic movies with a happy ending”
“Short animated film that talks about family values”
“Are there blockbuster movies from 1990s that involves a tragedy?”
“What is that movie where there is a Samoan warrior and a girl going on a sea adventure?
“What are some most critically-acclaimed dramas right now?” and
“I want to see a film set in Tuscany but is not dubbed in English.”

In response to such a query, the user may be provided with one or more recommendations, or search results, from which to select.

In addition and/or as an alternative to providing text-based or verbal queries to find content, such as described above, users may indicate their preferences for and/or aversions or distaste for certain items of content or types of content in non-verbal ways. Such non-verbal forms of expression may include facial expressions, kinesics, paralinguistics, body language and posture, gaze, and physiological responses. The non-verbal expression may occur in response to a stimulus provided to the user in order to determine what content a user would like to consume at a given time.

For example, when presented with a particular item of content, a user's facial expression (e.g., a smile, a frown, a grimace, raised eyebrows) may indicate the user's reaction to the content. Other non-verbal indications of a user's reaction to an item of content may include the user's averting their gaze from the display of the item of content or making non-verbal noises (e.g., a gasp, a scream, a sigh). Additional non-verbal indications of a user's reaction to an item of content may include symptoms of sympathetic arousal, such as one or more of heart rate variability (HRV), electrodermal activity (EDA), pupil opening and/or eye movement. Non-verbal indications of a user's reaction to an item of content may further include analysis of facial emotion to detect the user's reaction (e.g., the user is visibly surprised or horrified by content and their facial expression(s) reflect their response) or detection of gestures (e.g., the user raises their hands in despair, claps their hands in celebration, holds their head in shock, or is browsing on their mobile phone showing clear disinterest in the content).

In particular embodiments, subvocalization signals may be detected by sensors incorporated into a headset and/or other device worn by a user such that a user's reaction to a particular item of content may be determined by decoding the detected signals. In one embodiment, a headset for detecting subvocalization signals may include electrodes positioned on the face and jaw of the user to pick up neuromuscular signals triggered by internal verbalizations. The signals may then be provided to a machine-learning or other processing system that has been trained to correlate particular signals to a particular item of content presented and/or a scene from the content, as well as particular words.

It will be recognized that in certain situations, multiple users may be assembled, either in person or virtually, to consume content collectively and substantially simultaneously. In such cases, the responses of all of the users to particular stimuli may need to be considered in recommending content for consumption by the group.

In some embodiments, the group-selected content may be slightly modified for a user of the group based on the response of the user to the stimulus, assuming each user has their own audio and/or display device (collectively an A/V device). For example, for a user who has been determined to be particularly squeamish based on previous non-verbal reactions to scenes involving bloodshed, the user's audio may be muted and/or video may be blurred during similar scenes in group-selected content.

In particular embodiments, the non-verbal reactions of a user may be monitored throughout the user's consumption of content and the reactions used to modify the content and/or make alternative recommendations “on-the-fly” and/or the next time the user searches for content.

In accordance with features of embodiments described herein, items of content may be categorized by type, such that a user's reaction to one item of content of a particular type may be used as an indication of how the user may respond to a majority of items of content of that type. For example, if a user reacts negatively to an item of content that has been categorized as “horror,” it may be assumed that the user would react negatively to all items of content categorized as horror. Drilling down further, if a user reacts negatively to a certain type of violence in an item of content (e.g., violent acts that result in bloodshed) but not to another type of violence in an item of content (e.g., physical pushing or shoving that does not result in serious bodily injury to any of the participants), such information may be used to select items of content in the future. The foregoing concepts can also be extended to particular scenes in content, such that if a user reacts negatively to a particular scene in a content, it may be assumed user will react negatively to similar scenes in other content. For example, if a user reacts negatively to a murder scene in a crime movie, then we can use this signal in the recommendation model to indicate user did not like murder scenes, and take action to mute out or blur such scenes in other content, even if it is not a crime movie.

### Example Multimedia Environment

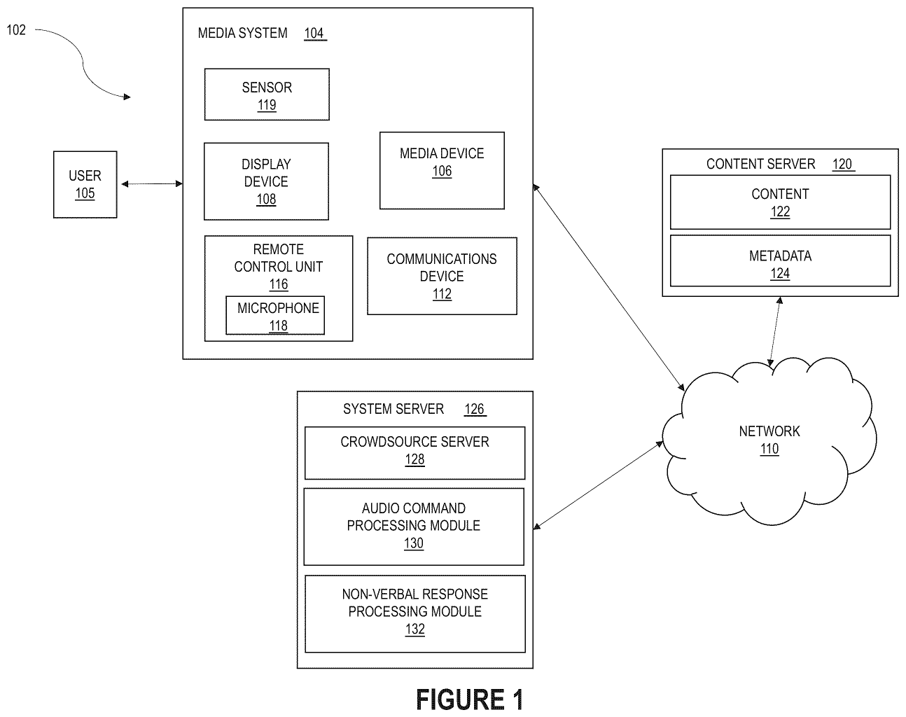

FIG. 1 illustrates a block diagram of an example multimedia environment 102 according to some embodiments described herein. In a non-limiting example, multimedia environment 102 may be directed to streaming media; however, embodiments described herein may be applicable to any type of media instead of or in addition to streaming media, as well as any type of mechanism, means, protocol, method, and/or process for distributing media.

Multimedia environment 102 may include one or more media systems, such as media system 104. Media system 104 may represent a family room, a kitchen, a backyard, a home theater, a school classroom, a library, a car, a boat, a bus, a plane, a stadium, a movie theater, an auditorium, a bar, a restaurant, an extended reality (XR) space, and/or any other location or space where it may be desirable to receive, interact with, and/or play streaming content. Users, such as a user 105, may interact with media system 104 as described herein to select, view, interact with, and/or otherwise consume content.

Each media system 104 may include one or more media devices, such as media device 106, each of which may be coupled to one or more display devices, such as display device 108 (which may be implemented as an A/V device). It will be noted that terms such as “coupled,” “connected,” “attached,” “linked,” “combined,” as well as similar terms, may refer to physical, electrical, magnetic, local and/or other types of connections, unless otherwise specified herein.

Media device 106 may include a streaming media device, DVD or BLU-RAY device, audio/video playback device, cable box, an XR device (which may include one or more of a VR device, an AR device, and an MR device), and/or digital video recording device, for example. Display device 108 may include a monitor, a television, a computer, a smart phone, a tablet, a wearable (e.g., a watch, glasses, goggles and/or an XR headset), an appliance, an Internet of things (IoT) device, and/or a projector, for example. In some embodiments, media device 106 may be a part of, integrated with, operatively coupled to, and/or connected to one or more respective display devices, such as display device 108.

Media device 106 may be configured to communicate with network 110 via a communications device 112. Communications device 112 may include, for example, a cable modem or satellite TV transceiver. Media device 106 may communicate with the communications device 112 over a link that may include wireless (e.g., Wi-Fi) and/or wired connections.

In various embodiments, network 110 may include, without limitation, wired and/or wireless intranet, extranet Internet, cellular, Bluetooth, infrared, and/or any other short range, long range, local, regional, and/or global communications mechanism, means, approach, protocol, and/or network, as well as any combinations thereof.

Media system 104 may include a remote control device 116. Remote control device may include and/or be incorporated into any component, part, apparatus, and/or method for controlling media device 106 and/or display device 108, such as a remote control, a tablet, a laptop computer, a smartphone, a wearable, on-screen controls, integrated control buttons, audio controls, XR equipment, and/or any combination thereof, for example, In one embodiment, remote control device 116 wirelessly communicates with media device 106 and/or display device 108 using any wireless communications protocol. Remote control device 116 may include a microphone 118. Media system 104 may also include one or more sensors, such as sensor 119, which may be deployed for tracking movement of user 105, such as in connection with XR applications. In particular embodiments, sensor 119 may include one or more of a gyroscope, a motion sensor, a camera, an IMU, and a biometric sensor, for example. Sensor 119 may also include one or more sensing devices for sensing biometric characteristics associated with sympathetic arousal, including one or more of heart rate variability (HRV), electrodermal activity (EDA), pupil opening, and/or eye movement. In some embodiments, sensors, such as sensor 119, may be incorporated into a device to be worn by users, such as a headset or vest. In particular embodiments, sensor 119 may comprise any sort of XR device.

Multimedia environment 102 may include a plurality of content servers 120, which may also be referred to as content providers or sources. Although only one content server 120 is shown in FIG. 1, multimedia environment 102 may include any number of content servers 120, each of which may be configured to communicate with network 110. Content servers 120 may be managed by one or more content providers. Each content server 120 may store content 122 and metadata 124. Content 122 may include media content, such as audio content, video content, image content, XR (e.g., VR, AR, and/or MR) content, gaming application content, advertising content, software content, and/or any other content or data objects in electronic form. Features or attributes of content 122 may include but are not limited to popularity, topicality, trend, statistical change, most-talked or most-discussed about, critics ratings, viewers ratings, length/duration, demographic-specific popularity, segment-specific popularity, region-specific popularity, cost associated with a content item, revenue associated with a content item, subscription associated with a content item, and amount of advertising, for example.

In particular embodiments, metadata 124 may include data about content 122. For example, metadata 124 may include but is not limited to such information pertaining or relating to content 122 as plot line, synopsis, director, list of actors, list of artists, list of athletes/teams, list of writers, list of characters, length of content item, language of content item, country of origin of content item, genre, category, tags, presence of advertising content, viewers' ratings, critic's ratings, parental ratings, production company, release date, release year, platform on which the content item is released, whether it is part of a franchise or series, type of content item, sports scores, viewership, popularity score, minority group diversity rating, audio channel information, availability of subtitles, beats per minute, list of filming locations, list of awards, list of award nominations, seasonality information, scene and video understanding, and emotional understanding of the scene based on visual and dialogue cues, for example. Metadata 124 may additionally or alternatively include links to any such information pertaining to or relating to content 122. Metadata 124 may additionally or alternatively include one or more indices of content 122.

Multimedia environment 102 may include one or more system servers 126, which operate to support media devices 106 from the cloud. In particular embodiments, structural and functional aspects of system servers 126 may wholly or partially exist in the same or different ones of system servers 126.

Media devices, such as media device 106, may exist in numerous media systems, such as media system 104. Accordingly, media devices 106 may lend themselves to crowd sourcing embodiments and system servers 126 may include one or more crowdsource servers 128. System servers 126 may also include an audio command processing module 130 and a non-verbal response processing module 132. As noted above, remote control device 116 may include a microphone 118, which may receive audio data from user 105 as well as from other sources, such as display device 108. In some embodiments, media device 106 may be audio responsive and the audio data may represent verbal commands from user 105 to control media device 106 as well as other components in media system 104, such as display device 108.

In some embodiments audio data received by microphone 118 is transferred to media device 106, which is then forwarded to audio command processing module 130. The audio command processing module 130 may operate to process and analyze the received audio data to recognize a verbal command from user 105. Audio command processing module 130 may then forward the verbal command to media device 106 for processing. In some embodiments, audio data may be additionally or alternatively processed and analyzed by an audio command processing module in media device 106 and system servers 126 may cooperate to select one of the verbal commands to process.

In some embodiments non-verbal data received by sensors 119, as will be described in greater detail below, is transferred to media device 106, which is then forwarded to non-verbal response data processing module 132. The non-verbal response data processing module 132 may operate to process and analyze the received sensor data to recognize one or more non-verbal responses from user 105 in response to stimuli, which may include items of content. Non-verbal response data processing module 132 may then forward the non-verbal response information to media device 106 for processing. In some embodiments, sensor data may be additionally or alternatively processed and analyzed by a non-verbal response data processing module in media device 106 and system servers 126 may cooperate to select one or more of the responses to process.

### Example Media Device

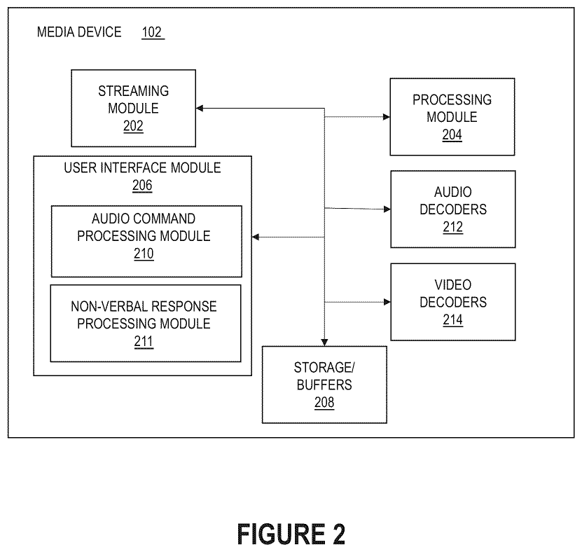

FIG. 2 illustrates a block diagram of an example media device 106 according to some embodiments. Media device 106 may include a streaming module 202, processing module 204, a user interface module 206, and storage/buffers 208. As noted above, user interface module 206 may include an audio command processing module 210 and a non-verbal response processing module 211.

As shown in FIG. 2, media device 106 may also include one or more audio decoders 212 and one or more video decoders 214. Each audio decoder 212 may be configured to decode one or more audio formats, including but not limited to AAC, HE-AAC, AD3 (Dolby Digital), EAC3 (Dolby Digital Plus), WMA, WAV, PCM, MP3, OGG GSM, FLAC, AU, AIFF, and/or VOX, for example. Similarly, each video decoder 214 may be configured to decode video of one or more video formats, including but not limited to MP4 (e.g., mp4, m4a, m4v, f4v, f4a, m4b, m4r, f4b, mov), 3GP (e.g., 3gp, 3gp2, 3g2, 3gpp, 3gpp2), OGG (e.g., ogg, oga, ogv, ogx), WMV (e.g., wmv, wma, asf), WEBM, FLV, AVI, QuickTime, HDV, MXF, MPEG-TS, MPEG-2 PS, MPEG-2 TS, WAV, Broadcast WAV, LXF, GXF, and/or VOB, for example. Each video decoder 214 may include one or more video codecs, such as H.263, H.264, H.265, HEV, MPEG1, MPEG2, MPEG-TS, MPEG-4, Theora, 3GP, DV, DVCPRO, DVCProHD, IMX, XDCAM HD, XDCAM HD422, AND XDCAM EX, for example.

Referring now to both FIGS. 1 and 2, in some embodiments, user 105 may interact with media device 106 via, for example, remote control device 116. For example, user 105 may use remote control device 116 to interact with user interface module 206 of the media device 106 to select content, such as a movie, TV show, music, book, application, game, etc. The streaming module 202 of media device 106 may request the selected content from content servers 120 over network 110. Content servers 120 may transmit the requested content to the streaming module 202. Media device 106 may transmit the received content to the display device 108 for playback to user 105.

In streaming embodiments, streaming module 202 may transmit content to display device 108 in real time or near real time as it receives such content from content servers 120. In non-streaming embodiments, media device 106 may store content received from content servers 120 in storage/buffers 208 for later playback on display device 108, for example.

### Example Techniques for Providing Content Recommendations

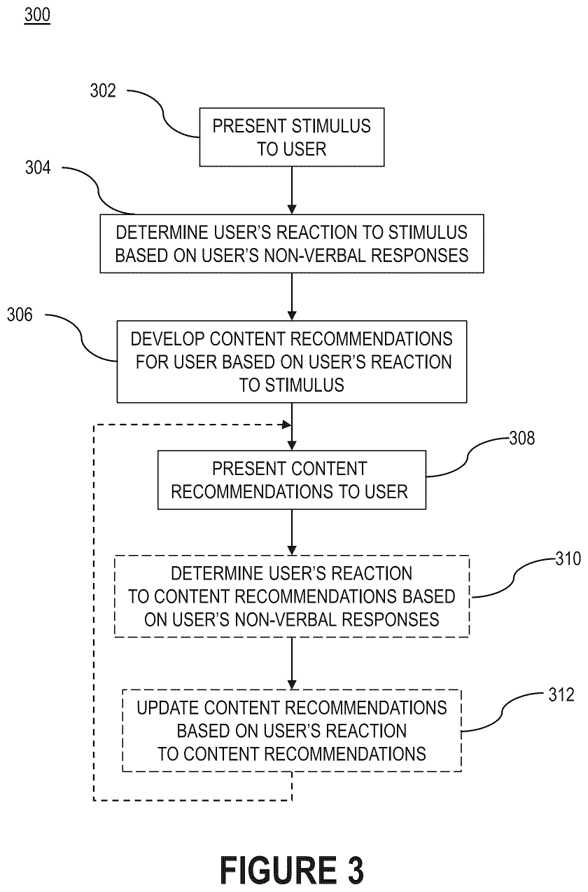

FIG. 3 is a flow diagram 300 of example operations performed in connection with techniques for providing content recommendation according to some embodiments of the disclosure. In certain embodiments, one or more of the operations illustrated in FIG. 3 shown in FIGS. 1 and/or 2, for example.

In operation 302, a stimulus is presented to a user. The stimulus may be presented in response to the user's indicating that they would like recommendations for content to consume. The stimulus may include one or more items of content (or portions of one or more items of content) and may be selected based on a variety of factors, including characteristics of the particular user and/or characteristics associated with demographics of the user, as well as Characteristics of user engagement on the streaming platform, content details, preference for each user in multiple-user households, time context (time of day, month, day of week, time correlation to when the user exercised the same preference previously). In general, the stimulus may be selected to elicit a non-verbal reaction from which the user's response to the stimulus can be assessed. For example, the stimulus may be a still image of a particular actor, a scene from a movie that the user has recently consumed via the system 100 (FIG. 1), or an advertisement for an item that someone having similar demographic characteristics of the user would typically find appealing.

In operation 304, the user's reaction to the stimulus presented in operation 302 is determined or otherwise assessed based on the user's non-verbal responses to the stimulus. For example, the user may smile, groan, gasp, roll their eyes, avert their gaze, cover their mouth with a hand, laugh, or otherwise respond to the stimulus. Any and all such non-verbal responses of the user may be detected (e.g., via sensing devices such as cameras, microphones, specially designed wearables, etc.) provided for such purpose. In particular embodiments, a wearable may enable subvocalization signals of the user to be detected such that the user's unspoken thoughts about the stimulus may be determined by analyzing movements of the user's facial muscles. The detected non-verbal responses may then be processed, analyzed, or otherwise evaluated (e.g., using artificial intelligence (AI), machine learning (ML), and/or other tools) to determine or otherwise categorize the user's reaction to the stimulus. It will be recognized that multiple stimuli may be presented to the user, with the user's reaction to each such stimulus determined in the aforementioned manner.

In operation 306, content recommendations are developed for the user based on the user's reaction(s) to the one or more stimuli. For example, if the user's reaction(s) indicated a positive response to comedy or a particular actor, comedies in which that actor or a similar actor appears may feature prominently in the content recommendations. If the user's reaction(s) indicated a negative response to drama or to a particular subject matter, then the content recommendations would likely be devoid of such content and perhaps feature the opposite. In particular embodiments, the content recommendations, along with the user's reactions and/or non-verbal responses, may be stored in connection with the user (e.g., in a user profile) for future use. Similarly, any such stored information may be considered in operation 306, with current reactions perhaps being weighted more heavily than previous ones, to account for changes in user mood and/or preferences. In particular embodiments, the instead of being based on stored information, the weights are learned by the specific models trained on the user engagement data. For example, a model optimizing for user engagement can decide to weight user reactions more heavily than other data, while a model optimizing for user revenue or user subscription video on demand (SVOD) engagement might weight the signals differently.

It should be noted that metadata associated with the stimulus as well as other content may be used to develop content recommendations based on the user's reaction(s) to the one or more stimuli and that generalizations may be drawn based on the metadata.

In operation 308, the content recommendations developed in operation 306 are presented to the user. For example, the content recommendations may be presented to the user on a display of the multimedia system. In particular embodiments, if at this point, the user selects one of the recommendations (e.g., using the remote control of the system), the content may be presented to the user.

Alternatively, in optional operation 310, the user's reaction to one or more of the content recommendations may be evaluated in a manner similar to that described with reference to operation 304. For example, detection that the user's gaze is drawn to a few different ones of the recommendations may indicate that the user is somewhat interested in those recommendations but not enough to select one of them outright.

In optional operation 312, the information gleaned in operation 310 is used to update the content recommendations in a manner similar to that described above with reference to operation 306. Execution then returns to operation 308, at which the (updated) content recommendations are presented to the user.

Operations 308-312 may be repeated until the user selects one of the recommendations, at which point, the session may terminate. Additionally and/or alternatively, rather than presenting content recommendations to the user in operation 306, the result of operations 302 and 304 could be used to select advertising content to be presented to the user during the user's consumption of other content in an attempt to identify advertising content that may be positively received by the user.

Although the operations of the example method shown in and described with reference to FIG. 3 are illustrated as occurring once each and in a particular order, it will be recognized that the operations may be performed in any suitable order and repeated as desired. Additionally, one or more operations may be performed in parallel. Furthermore, the operations illustrated in FIG. 3 may be combined or may include more or fewer details than described.

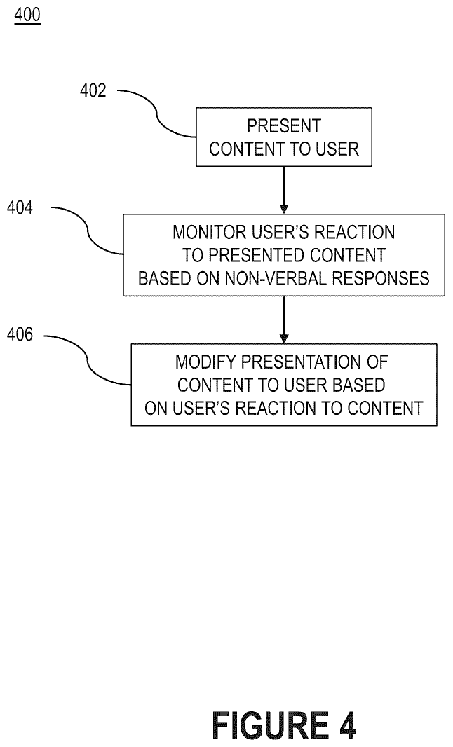

FIG. 4 is a flow diagram 400 of example operations performed in connection with techniques for providing content recommendation according to other embodiments of the disclosure. In certain embodiments, one or more of the operations illustrated in FIG. 4 shown in FIGS. 1 and/or 2, for example.

In operation 402, content is presented to the user (e.g., via a display associated with a multimedia system, such as system 100). The presented content may be content selected by the user during a search session such as that illustrated in FIG. 3.

In operation 404, the user's reaction to the presented content is monitored. In particular, the user's non-verbal responses to the content is detected and assessed in a manner similar to that escribed with reference to operation 304 (FIG. 3). In particular embodiments, the user's reactions in the form of non-verbal responses may be tracked and associated with particular scenes, or tiles, of the presented content such that there is a correlation between the user's responses and the aspects of the content provoking the responses. In other words, the presented content functions as a series of stimuli similar to that of the technique shown in FIG. 3.

In operation 406, the presented content (and/or the presentation of the content) may be modified based on the user's reaction to the content as determined in operation 404. For example, if the user's reaction is extreme, presentation of the content may be terminated and the user prompted to indicate whether they would like to select different content. Alternatively, in particular embodiments, audio and/or visual aspects of the presented content itself may be modified (e.g., audio and/or video of entire scenes or scene elements scenes obscured, changed, replaced or otherwise modified from their original format). In yet another alternative, presentation of content maybe blocked rather than terminated. Still further, the content may be paused and the user presented with an option to select another title and/or exit the current title.

It will be noted that while user reaction to content may be extreme, such an extreme reaction does not necessarily mean the that the user does not want to continue viewing the content. user does not want to continue viewing it.

Although the operations of the example method shown in and described with reference to FIG. 4 are illustrated as occurring once each and in a particular order, it will be recognized that the operations may be performed in any suitable order and repeated as desired. Additionally, one or more operations may be performed in parallel. Furthermore, the operations illustrated in FIG. 4 may be combined or may include more or fewer details than described.

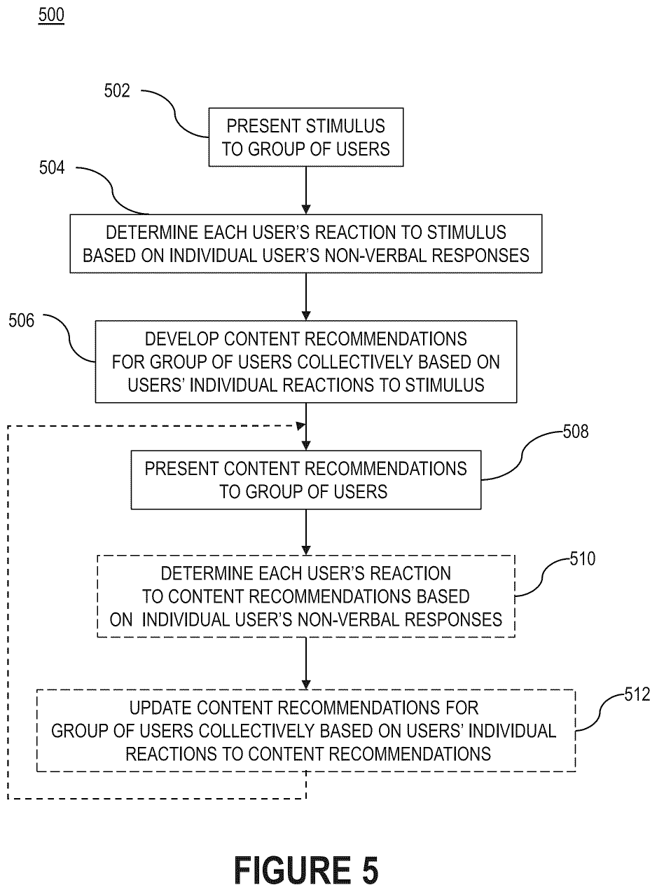

FIG. 5 is a flow diagram 500 of example operations performed in connection with techniques for providing content recommendation according to still other embodiments of the disclosure. In certain embodiments, one or more of the operations illustrated in FIG. 5 shown in FIGS. 1 and/or 2, for example. The technique illustrated in FIG. 5 is similar to that illustrated in FIG. 3 except that the technique illustrated in FIG. 5 is directed to a group of users who desire to consume the same (or substantially the same, as will be described below) content substantially simultaneously while gathered in the same physical location or while assembled virtually.

In operation 502, a stimulus is presented to a group of users. The stimulus may be provided via a single display device, such as may be the case if all of the users are in the same room, or via multiple display devices, as may be the case if the users are viewing the content in different locations or via headsets (such as with an XR application). The stimulus may be presented in response to the group of users indicating that they would like recommendations for content to consume collectively. The stimulus may include one or more items of content (or portions of one or more items of content) and may be selected based on a variety of factors, including characteristics of the users and/or characteristics associated with demographics of the users. In general, the stimulus may be selected to elicit non-verbal reactions from which the users' responses to the stimulus can be assessed, as described above.

In operation 504, the users' reactions to the stimulus presented in operation 502 are determined or otherwise assessed based on the users' non-verbal responses to the stimulus. For example, users may smile, groan, gasp, roll their eyes, avert their gaze, cover their mouth with a hand, laugh, or otherwise respond to the stimulus. Any and all such non-verbal responses of the users may be detected individually (e.g., via sensing devices such as cameras, microphones, specially designed wearables, etc., provided for such purpose). The detected non-verbal responses may then be processed, analyzed, or otherwise evaluated (e.g., using artificial intelligence (AI), machine learning (ML), and/or other tools) to determine or otherwise categorize each user's reaction to the stimulus. It will be recognized that multiple stimuli may be presented to the users, with the users' reaction to each such stimulus determined in the aforementioned manner.

In operation 506, content recommendations are developed for the group of users collectively based on the users' reactions to the one or more stimuli. It will be recognized that various techniques for determining a collective recommendation may be deployed, including, for example, applying a weighted average of reactions or applying a round robin selection process (e.g., for groups of users who regularly consume content together). Additionally, models may be trained to learn different preferences of different users in a multi-user household environment, which may be leveraged in this operation as well. In particular embodiments, the content recommendations, along with the users' reactions and/or non-verbal responses, may be stored in connection with the users individually and/or collectively (e.g., in user profiles) for future use. Similarly, any such stored information may be considered in operation 506, with current reactions perhaps being weighted more heavily than previous ones, to account for changes in users' moods and/or preferences. It should be noted that metadata associated with the stimulus as well as other content may be used to develop content recommendations based on the users' reactions to the one or more stimuli and that generalizations may be drawn based on the metadata.

In operation 508, the content recommendations developed in operation 506 are presented to the users. For example, the content recommendations may be presented to the users on a display of the multimedia system. In particular embodiments, if at this point, the users select one of the recommendations (e.g., using the remote control of the system), the content may be presented to the users and no further recommendations are made during the current search session.

Alternatively, in optional operation 510, the users' reactions to one or more of the content recommendations may be evaluated in a manner similar to that described with reference to operation 504. For example, detection that the various users' gazes are drawn to a few different ones of the recommendations may indicate that the users are somewhat interested in those recommendations but not enough to select one of them outright.

In optional operation 512, the information gleaned in operation 510 is used to update the content recommendations in a manner similar to that described above with reference to operation 506. Execution then returns to operation 508, at which the (updated) content recommendations are presented to the users.

Operations 508-512 may be repeated until the user group selects one of the recommendations, at which point, the session may terminate. Additionally and/or alternatively, rather than presenting content recommendations to the users in operation 506, the result of operations 502 and 504 could be used to select advertising content to be presented to the users during the user groups' consumption of other content in an attempt to identify advertising content that may be positively received by the users.

Although the operations of the example method shown in and described with reference to FIG. 5 are illustrated as occurring once each and in a particular order, it will be recognized that the operations may be performed in any suitable order and repeated as desired. Additionally, one or more operations may be performed in parallel. Furthermore, the operations illustrated in FIG. 5 may be combined or may include more or fewer details than described.

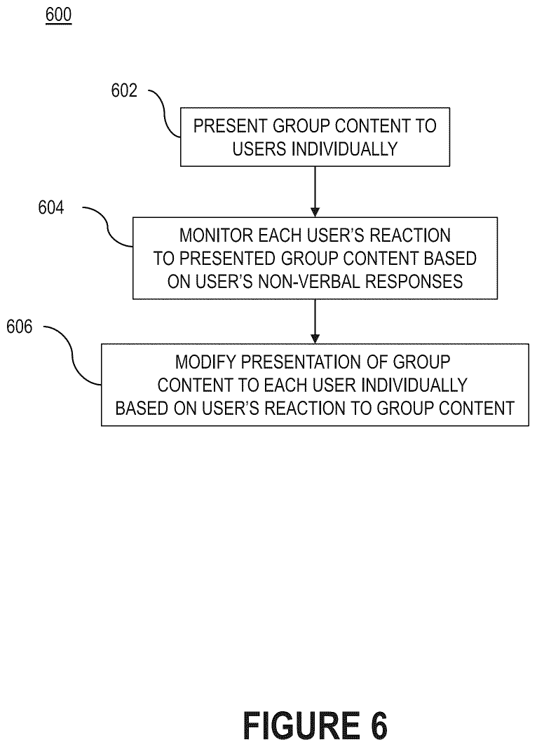

FIG. 6 is a flow diagram 600 of example operations performed in connection with techniques for providing content recommendation according to yet other embodiments of the disclosure. In certain embodiments, one or more of the operations illustrated in FIG. 6 shown in FIGS. 1 and/or 2, for example. The technique illustrated in FIG. 6 is similar to that illustrated in FIG. 5 except that the technique illustrated in FIG. 6 is directed to a group of users who desire to consume the same (or substantially the same, as will be described below) content substantially simultaneously while gathered in the same physical location or while assembled virtually.

In operation 602, content is presented to the users (e.g., via a display or displays associated with a multimedia system, such as system 100). The presented content may be content selected by the users during a search session such as that illustrated in FIG. 5. It will be recognized that in certain implementations, each user may have their own display and that such displays may be associated with headsets, such as in XR applications.

In operation 604, the reactions of each user to the presented content are monitored. In particular, the users' non-verbal responses to the content are detected and assessed in a manner similar to that described with reference to operation 504 (FIG. 5). In particular embodiments, the users' reactions in the form of non-verbal responses may be tracked and associated with particular scenes, or tiles, of the presented content such that there is maintained a correlation between the users' responses and the aspects or features of the presented content provoking the responses. In other words, the presented content functions as a series of stimuli similar to that of the technique shown in FIG. 5.

In operation 606, the presented content (and/or the presentation of the content) may be modified on a per user basis based on the particular user's reaction to the content as determined in operation 604. For example, if the user's reaction is extreme, presentation of the content may be terminated, blocked, blurred, and/or paused and the user prompted to indicate whether they would like to select different content. Alternatively, in particular embodiments, audio and/or visual aspects of the presented content itself may be modified (e.g., audio and/or video of entire scenes or scene elements scenes obscured, changed, replaced or otherwise modified from their original format). Alternatively, in system configurations in which each user does not have their own individual A/V system, for example, the content presented to the group as a whole may be modified as deemed appropriate.

Although the operations of the example method shown in and described with reference to FIG. 6 are illustrated as occurring once each and in a particular order, it will be recognized that the operations may be performed in any suitable order and repeated as desired. Additionally, one or more operations may be performed in parallel. Furthermore, the operations illustrated in FIG. 6 may be combined or may include more or fewer details than described.

### Example Processing Device

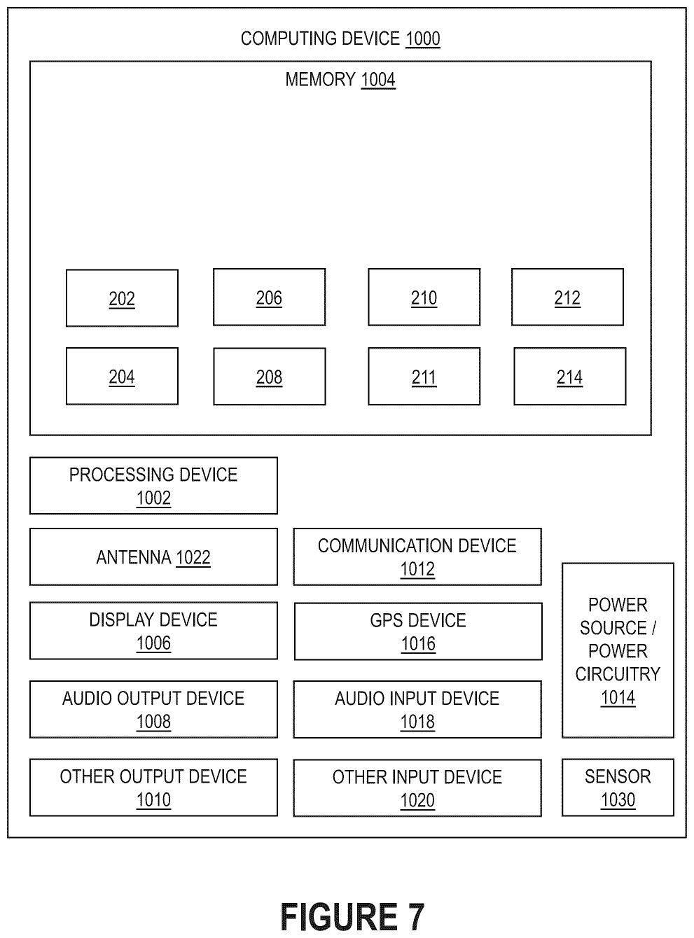

FIG. 7 is a block diagram of an example processing, or computing, device 1000, according to some embodiments of the disclosure. One or more computing devices, such as computing device 1000, may be used to implement the functionalities described with reference to the FIGURES and herein. A number of components are illustrated in the FIGURES as included in the computing device 1000, but any one or more of these components may be omitted or duplicated, as suitable for the application. In some embodiments, some or all of the components included in the computing device 1000 may be attached to one or more motherboards. In some embodiments, some or all of these components are fabricated onto a single system on a chip (SoC) die. Additionally, in various embodiments, the computing device 1000 may not include one or more of the components illustrated in FIG. 7, and the computing device 1000 may include interface circuitry for coupling to the one or more components. For example, the computing device 1000 may not include a display device 1006, and may include display device interface circuitry (e.g., a connector and driver circuitry) to which a display device 1006 may be coupled. In another set of examples, the computing device 1000 may not include an audio input device 1018 or an audio output device 1008 and may include audio input or output device interface circuitry (e.g., connectors and supporting circuitry) to which an audio input device 1018 or audio output device 1008 may be coupled.

The computing device 1000 may include a processing device 1002 (e.g., one or more processing devices, one or more of the same type of processing device, one or more of different types of processing device). The processing device 1002 may include electronic circuitry that process electronic data from data storage elements (e.g., registers, memory, resistors, capacitors, quantum bit cells) to transform that electronic data into other electronic data that may be stored in registers and/or memory. Examples of processing device 1002 may include a central processing unit (CPU), a graphical processing unit (GPU), a quantum processor, a machine learning processor, an artificial-intelligence processor, a neural network processor, an artificial intelligence accelerator, an application specific integrated circuit (ASIC), an analog signal processor, an analog computer, a microprocessor, a digital signal processor.

The computing device 1000 may include a memory 1004, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 1004 includes one or more non-transitory computer-readable storage media. In some embodiments, memory 1004 may include memory that shares a die with the processing device 1002. In some embodiments, memory 1004 includes one or more non-transitory computer-readable media storing instructions executable to perform operations described with the FIGURES and herein, such as the methods illustrated in FIGS. 3-6. Exemplary parts or modules that may be encoded as instructions and stored in memory 1004 are depicted. Memory 1004 may store instructions that encode one or more exemplary parts. The instructions stored in the one or more non-transitory computer-readable media may be executed by processing device 1002. In some embodiments, memory 1004 may store data, e.g., data structures, binary data, bits, metadata, files, blobs, etc., as described with the FIGURES and herein. Exemplary data that may be stored in memory 1004 are depicted. Memory 1004 may store one or more data as depicted.

In some embodiments, the computing device 1000 may include a communication device 1012 (e.g., one or more communication devices). For example, the communication device 1012 may be configured for managing wired and/or wireless communications for the transfer of data to and from the computing device 1000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 1012 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 1012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 1012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 1012 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 1012 may operate in accordance with other wireless protocols in other embodiments. The computing device 1000 may include an antenna 1022 to facilitate wireless communications and/or to receive other wireless communications (such as radio frequency transmissions). The computing device 1000 may include receiver circuits and/or transmitter circuits. In some embodiments, the communication device 1012 may manage wired communications, such as electrical, optical, or any other suitable communication protocols (e.g., the Ethernet). As noted above, the communication device 1012 may include multiple communication chips. For instance, a first communication device 1012 may be dedicated to shorter-range wireless communications such as Wi-Fi or Bluetooth, and a second communication device 1012 may be dedicated to longer-range wireless communications such as global positioning system (GPS), EDGE, GPRS, CDMA, WiMAX, LTE, EV-DO, or others. In some embodiments, a first communication device 1012 may be dedicated to wireless communications, and a second communication device 1012 may be dedicated to wired communications.

The computing device 1000 may include power source/power circuitry 1014. The power source/power circuitry 1014 may include one or more energy storage devices (e.g., batteries or capacitors) and/or circuitry for coupling components of the computing device 1000 to an energy source separate from the computing device 1000 (e.g., DC power, AC power, etc.).

The computing device 1000 may include a display device 1006 (or corresponding interface circuitry, as discussed above). The display device 1006 may include any visual indicators, such as a heads-up display, a computer monitor, a projector, a touchscreen display, a liquid crystal display (LCD), a light-emitting diode display, or a flat panel display, for example.

The computing device 1000 may include an audio output device 1008 (or corresponding interface circuitry, as discussed above). The audio output device 1008 may include any device that generates an audible indicator, such as speakers, headsets, or earbuds, for example.

The computing device 1000 may include an audio input device 1018 (or corresponding interface circuitry, as discussed above). The audio input device 1018 may include any device that generates a signal representative of a sound, such as microphones, microphone arrays, or digital instruments (e.g., instruments having a musical instrument digital interface (MIDI) output).

The computing device 1000 may include a GPS device 1016 (or corresponding interface circuitry, as discussed above). The GPS device 1016 may be in communication with a satellite-based system and may receive a location of the computing device 1000, as known in the art.

The computing device 1000 may include a sensor 1030 (or one or more sensors). The computing device 1000 may include corresponding interface circuitry, as discussed above). Sensor 1030 may sense physical phenomenon and translate the physical phenomenon into electrical signals that can be processed by, e.g., processing device 1002. Examples of sensor 1030 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 1000 may include another output device 1010 (or corresponding interface circuitry, as discussed above). Examples of the other output device 1010 may include an audio codec, a video codec, a printer, a wired or wireless transmitter for providing information to other devices, haptic output device, gas output device, vibrational output device, lighting output device, home automation controller, or an additional storage device.

The computing device 1000 may include another input device 1020 (or corresponding interface circuitry, as discussed above). Examples of the other input device 1020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1000 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, the computing device 1000 may be any other electronic device that processes data.

### Selected Examples

Example 1 provides a method including presenting a stimulus to a user, wherein the stimulus includes at least a portion of a first item of content and includes audio, video, or both; detecting at least one non-verbal reaction of the user to the stimulus; processing the detected at least one non-verbal reaction to determine a response of the user to the stimulus; providing to the user a list of recommendations based on the determined response of the user to the stimulus, wherein the list of recommendations includes at least one second item of content selected from a content database; and prompting the user to select an item of content from the list of recommendations.

Example 2 provides the method of example 1, wherein the detected non-verbal reaction includes at least one of a facial expression, kinesics, paralinguistics, body language, posture, gaze, or a physiological response of the user.

Example 3 provides the method of example 1 or 2, wherein the detected non-verbal reaction includes subvocalization signals.

Example 4 provides the method of example 3, wherein the subvocalization signals are detected using an electrode positioned on a jaw of the user to detect neuromuscular signals.

Example 5 provides the method of any of examples 1-4, wherein the presenting is performed using a standalone display.

Example 6 provides the method of any of examples 1-5, wherein the presenting is performed using a display incorporated into device worn by the user.

Example 7 provides the method of any of examples 1-6, wherein the device includes an extended reality (XR) headset.

Example 8 provides the method of any of examples 1-7, wherein the detecting is performed using a sensor incorporated into a device worn by the user.

Example 9 provides the method of any of examples 1-8, further including detecting at least one non-verbal reaction of the user to the at least one second item of content; processing the detected at least one non-verbal reaction of the user to the at least one second item of content to determine a response of the user to the at least one second item of content; and updating the list of recommendations based on the determined response of the user to the at least one second item of content.

Example 10 provides the method of any of examples 1-9, further including presenting the selected item of content to the user; monitoring non-verbal reactions of the user to the selected item of content; processing the non-verbal reactions of the user to the selected item of content to determine a response of the user to the selected item of content; and modifying presentation of the selected item of content based on the determined response of the user to the selected item of content.

Example 11 provides a multimedia system including a processor; a memory device; a database including items of content, wherein each of the items of content has metadata associated therewith; at least one display for displaying selected ones of the items of content to a group of users; and at least one sensing device for detecting non-verbal reactions of each user of the group of users to a stimulus presented to the group of users on the at least one display, wherein the detected non-verbal reactions of the group of users are processed on a per-user basis to determine responses of the group of users the stimulus, and wherein the users are provided with a list of recommendations based on the determined responses of the group of users.

Example 12 provides the multimedia system of example 11, wherein the detected non-verbal reaction includes subvocalization signals and the sensing device includes at least one electrode positioned on a jaw of the user to detect neuromuscular signals.

Example 13 provides the multimedia system of any of examples 11-12, wherein the display includes a television display.

Example 14 provides the multimedia system of any of examples 11-13, wherein the at least one display includes a plurality of displays and wherein each one of the plurality of displays is incorporated into a device worn by a user of the group of users.

Example 15 provides the multimedia system of example 14, wherein the device includes an extended reality (XR) headset.

Example 16 provides the multimedia system of any of examples 11-15, wherein the at least one sensing device includes a plurality of sensing devices and wherein each one of the plurality of sensing devices is incorporated into a device worn by a user of the group of users.

Example 17 provides one or more non-transitory computer-readable storage media including instruction for execution which, when executed by a processor, result in operations including presenting a stimulus to a user, wherein the stimulus includes at least a portion of a first item of content and includes audio, video, or both; detecting at least one non-verbal reaction of the user to the stimulus; processing the detected at least one non-verbal reaction to determine a response of the user to the stimulus; providing to the user a list of recommendations based on the determined response of the user to the stimulus, wherein the list of recommendations includes at least one second item of content selected from a content database; and prompting the user to select an item of content from the list of recommendations, wherein the detected non-verbal reaction includes at least one of a facial expression, kinesics, paralinguistics, body language, posture, gaze, or a physiological response of the user.

Example 18 provides the one or more non-transitory computer-readable storage media of example 17, wherein the operations further include detecting at least one non-verbal reaction of the user to the at least one second item of content; processing the detected at least one non-verbal reaction of the user to the at least one second item of content to determine a response of the user to the at least one second item of content; and updating the list of recommendations based on the determined response of the user to the at least one second item of content.

Example 19 provides the one or more non-transitory computer-readable storage media computer-readable media of any of examples 17-18, wherein the operations further include presenting the selected item of content to the user; monitoring non-verbal reactions of the user to the selected item of content; processing the non-verbal reactions of the user to the selected item of content to determine a response of the user to the selected item of content; and modifying presentation of the selected item of content based on the determined response of the user to the selected item of content.

Example 20 provides the one or more non-transitory computer-readable storage media computer-readable media of example 19, wherein the user includes a group of users and wherein the monitoring the non-verbal reactions of the user to the selected item of content includes monitoring the non-verbal reactions of each user of the group of users to the selected item of content; wherein the processing the non-verbal reactions of the user to the selected item of content to determine a response of the user to the selected item of content includes processing the non-verbal reactions of each user of the group of users to the selected item of content to determine a response of the user to the selected item of content; and wherein the modifying presentation of the selected item of content based on the determined response of the user to the selected item of content further includes modifying presentation of the selected item of content to each user of the group of users based on the determined response of the user to the selected item of content.

### Variations and Other Notes

The above paragraphs provide various examples of the embodiments disclosed herein.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the above detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the above detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

What is claimed is:

1. A method comprising:
presenting a stimulus to a user, wherein the stimulus comprises at least a portion of a first item of content and includes audio, video, or both;
detecting at least one non-verbal reaction of the user to the stimulus;
processing the detected at least one non-verbal reaction to determine a response of the user to the stimulus;
providing to the user a list of recommendations based on the determined response of the user to the stimulus, wherein the list of recommendations comprises at least one second item of content selected from a content database; and
prompting the user to select an item of content from the list of recommendations.

2. The method of claim 1, wherein the detected non-verbal reaction comprises at least one of a facial expression, kinesics, paralinguistics, body language, posture, gaze, or a physiological response of the user.

3. The method of claim 1, wherein the detected non-verbal reaction comprises subvocalization signals.

4. The method of claim 3, wherein the subvocalization signals are detected using an electrode positioned on a jaw of the user to detect neuromuscular signals.

5. The method of claim 1, wherein the presenting is performed using a standalone display.

6. The method of claim 1, wherein the presenting is performed using a display incorporated into device worn by the user.

7. The method of claim 6, wherein the device comprises an extended reality (XR) headset.

8. The method of claim 1, wherein the detecting is performed using a sensor incorporated into a device worn by the user.

9. The method of claim 1, further comprising:
detecting at least one non-verbal reaction of the user to the at least one second item of content;
processing the detected at least one non-verbal reaction of the user to the at least one second item of content to determine a response of the user to the at least one second item of content; and
updating the list of recommendations based on the determined response of the user to the at least one second item of content.

10. The method of claim 1, further comprising:
presenting the selected item of content to the user;
monitoring non-verbal reactions of the user to the selected item of content;
processing the non-verbal reactions of the user to the selected item of content to determine a response of the user to the selected item of content; and
modifying presentation of the selected item of content based on the determined response of the user to the selected item of content.

11. A multimedia system comprising:
a processor;
a memory device;
a database comprising items of content, wherein each of the items of content has metadata associated therewith;
at least one display for displaying selected ones of the items of content to a group of users; and
at least one sensing device for detecting non-verbal reactions of each user of the group of users to a stimulus presented to the group of users on the at least one display;
wherein the detected non-verbal reactions of the group of users are processed on a per-user basis to determine responses of the group of users the stimulus; and
wherein the users are provided with a list of recommendations based on the determined responses of the group of users.

12. The system of claim 11, wherein the detected non-verbal reaction comprises subvocalization signals and the sensing device comprises at least one electrode positioned on a jaw of the user to detect neuromuscular signals.

13. The system of claim 11, wherein the display comprises a television display.

14. The system of claim 11, wherein the at least one display comprises a plurality of displays and wherein each one of the plurality of displays is incorporated into a device worn by a user of the group of users.

15. The system of claim 14, wherein the device comprises an extended reality (XR) headset.

16. The system of claim 11, wherein the at least one sensing device comprises a plurality of sensing devices and wherein each one of the plurality of sensing devices is incorporated into a device worn by a user of the group of users.

17. One or more non-transitory computer-readable storage media comprising instruction for execution which, when executed by a processor, result in operations comprising:
presenting a stimulus to a user, wherein the stimulus comprises at least a portion of a first item of content and includes audio, video, or both;
detecting at least one non-verbal reaction of the user to the stimulus;
processing the detected at least one non-verbal reaction to determine a response of the user to the stimulus;
providing to the user a list of recommendations based on the determined response of the user to the stimulus, wherein the list of recommendations comprises at least one second item of content selected from a content database; and
prompting the user to select an item of content from the list of recommendations;
wherein the detected non-verbal reaction comprises at least one of a facial expression, kinesics, paralinguistics, body language, posture, gaze, or a physiological response of the user.

18. The one or more non-transitory computer-readable storage media computer-readable media of claim 17, wherein the operations further comprise:
detecting at least one non-verbal reaction of the user to the at least one second item of content;
processing the detected at least one non-verbal reaction of the user to the at least one second item of content to determine a response of the user to the at least one second item of content; and
updating the list of recommendations based on the determined response of the user to the at least one second item of content.

19. The one or more non-transitory computer-readable storage media computer-readable media of claim 17, wherein the operations further comprise:
presenting the selected item of content to the user;
monitoring non-verbal reactions of the user to the selected item of content;
processing the non-verbal reactions of the user to the selected item of content to determine a response of the user to the selected item of content; and
modifying presentation of the selected item of content based on the determined response of the user to the selected item of content.

20. The one or more non-transitory computer-readable storage media computer-readable media of claim 19:
wherein the user comprises a group of users and wherein the monitoring the non-verbal reactions of the user to the selected item of content comprises monitoring the non-verbal reactions of each user of the group of users to the selected item of content;
wherein the processing the non-verbal reactions of the user to the selected item of content to determine a response of the user to the selected item of content comprises processing the non-verbal reactions of each user of the group of users to the selected item of content to determine a response of the user to the selected item of content; and
wherein the modifying presentation of the selected item of content based on the determined response of the user to the selected item of content further comprises modifying presentation of the selected item of content to each user of the group of users based on the determined response of the user to the selected item of content.
